(19) United States
(12) Patent Application Publication
(10) Pub. No.: US 2015/0293737 A1
(43) Pub. Date: Oct. 15, 2015

(54) NAVIGATIONAL CHART WITH REAL-TIME DEPTH INFORMATION AND SAFETY BOUNDARIES

(71) Applicant: Joseph P. Quinn, Norfolk, MA (US)

(72) Inventor: Joseph P. Quinn, Norfolk, MA (US)

(21) Appl. No.: 14/524,771

(22) Filed: Oct. 27, 2014

Related U.S. Application Data
(60) Provisional application No. 61/896,353, filed on Oct. 28, 2013.

(51) Int. Cl. G06F 3/13; G01B 21/18; G01C 21/04; G06F 3/14

(52) U.S. Cl. CPC G06F 3/13; G06F 3/1407; G01B 21/18; G01C 21/04

(57) ABSTRACT

An apparatus for displaying a navigational chart such as a navigational chart plotter includes real-time depth indicators displayed at corresponding locations on the navigational chart. The real time depth indicators display a real time water depth of each of the corresponding locations. The real time water depths are generated based on a predetermined depth of the corresponding location at a predetermined time relative to a tide cycle combined with a projected tide height at a selected time. Real-time safety boundaries may also be displayed for vessels of a defined draft based on the real-time depths information.

### CROSS REFERENCE TO RELATED APPLICATIONS

This application claims priority to U.S. Provisional Patent Application No. 61/896,353 entitled “Navigational Chart with Real-Time Depth Information and Safety Boundaries” which was filed on Oct. 28, 2013 and which is incorporated herein by reference in its entirety.

### FIELD OF THE INVENTION

The present disclosure relates to marine navigation and more particularly to electronic marine navigation displays.

### BACKGROUND

Marine navigation devices such as chart plotters generally display navigational charts including published depth soundings for numerous positions on a navigational chart display. The soundings represent the water depth at mean low tide for the location upon which they are displayed. To determine the depth at a particular time, a navigator typically adds or subtracts an adjustment factor to a sounding based on an estimates tide height at a time of interest. The estimated tide height is typically based on a published tide table for a location near the displayed sounding.

### SUMMARY

Aspects of the present disclosure include an apparatus for displaying a navigational chart with real-time depth indicators displayed at corresponding locations on the navigational chart. The real time depth indicators display a real time water depth of each of the corresponding locations, in which each of the real time water depths are generated based on a predetermined depth of the corresponding location at a predetermined time relative to a tide cycle combined with a projected tide height at a selected time.

Another aspect of the present disclosure includes a method for displaying a navigational chart. The method includes determining a real time water depth of each of a plurality of corresponding locations depicted on the navigational chart based on a predetermined depth of the corresponding locations at a predetermined time relative to a tide cycle combined with a projected tide height at a selected time. The method further includes displaying real-time depth indicators at a corresponding locations on the navigational chart.

Another aspect of the present disclosure includes an apparatus for displaying a navigational chart. The apparatus includes means for determining a real time water depth of each of a plurality of corresponding locations depicted on the navigational chart based on a predetermined depth of the corresponding locations at a predetermined time relative to a tide cycle combined with a projected tide height at a selected time. The apparatus also includes means for displaying real-time depth indicators at a corresponding locations on the navigational chart.

Another aspect of the present disclosure includes a navigational chart plotter including at least one processor. The processor(s) is/are programmed to perform steps of determining a real time water depth of each of a plurality of corresponding locations depicted on the navigational chart based on a predetermined depth of the corresponding locations at a predetermined time relative to a tide cycle combined with a projected tide height at a selected time. The processors are further configured to perform steps of generating an image including real-time depth indicators at a corresponding locations on the navigational chart. The navigational chart plotter also includes a memory coupled to the processor and a display coupled to the memory. According to this aspect, the memory is configured to store the image, the display is configured to display the image.

Another aspect of the present disclosure includes a non-transitory computer readable media storing computer program code. The computer program code when executed by a navigational device enables the navigational device to performs steps of determining a real time water depth of each of a plurality of corresponding locations depicted on the navigational chart based on a predetermined depth of the corresponding locations at a predetermined time relative to a tide cycle combined with a projected tide height at a selected time, and steps of generating an image including real-time depth indicators at a corresponding locations on the navigational chart.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a conceptual block diagram illustrating a navigational device for displaying real time depth information including to aspects of the present disclosure.

FIG. 2 is a process flow diagram illustrating a method for displaying a navigational chart according to aspects of the present disclosure.

FIG. 3 is a conceptual drawing of a display of real-time depth information according to aspects of the present disclosure.

### DETAILED DESCRIPTION

Traditional techniques for adjusting published depth soundings for a given time and location based on tide table information is cumbersome and introduces potential for errors. Aspects of the present disclosure automatically adjust the displayed depth soundings based on a real time tide estimate or measurement.

Different vessels have different drafts (depth below waterline) so areas that may be safe for some vessels having a shallow draft may be unsafe for other vessels having a deeper draft. Aspects of the present disclosure include displaying boundaries between safe areas and unsafe areas on a navigation chart at a given time based on a particular vessel draft and the estimated or measured tide height at the given time. The boundaries change as the tide ebbs and flows and as different vessel drafts may be selectively input by a user. In addition to entering a vessel draft, a user may typically add a safety margin to the entered draft. Alternatively, a safety margin may be automatically added to an vessel draft input.

According to aspects of the present disclosure, the depth sounding information to be adjusted for tide height at a given time and location may be published depth soundings from published marine navigational charts and conventional electronic chart databases, for example. A tide height adjustment factor to be combined with (added to or subtracted from) the depth sounding information for a given time and location may be may be based upon a published tide table for a location proximate to the given location, or may be computed based on the position of the moon and sun at a given time, for example. Tide height adjustments may also include weather related factors, in which the tide height projections for a given time and location may be received from an updated weather service, for example. Alternatively the tide height adjustment factor may be calculated by measuring the actual depth at a particular location using an on board depth sounder for example which may be coupled to the navigational display device. The difference between the actual depth and the published sounding information for a given location provides an adjustment factor for the given time. The adjustment factor can be combined with all of the published depth sounding and/or contours on a chart, or may be limited so some region proximate to the depth measurement or proximate to a tide station from which the adjustment factor is based.

According to aspects of the present disclosure, the boundaries may be determined, estimated and/or computed by linking similar published depth soundings, and/or by adjusting published depth contour information, which is commonly included on marine navigational charts and electronic chart displays.

A navigational chart display may depict the area around a vessel position based on a GPS location of the vessel, or alternatively, any area on any available chart may be selected by a user to be displayed. The adjusted soundings and boundaries displayed may be represent the time of display, i.e. real time depth information, or may be displayed for an alternative time selected by a user for planning purposes.

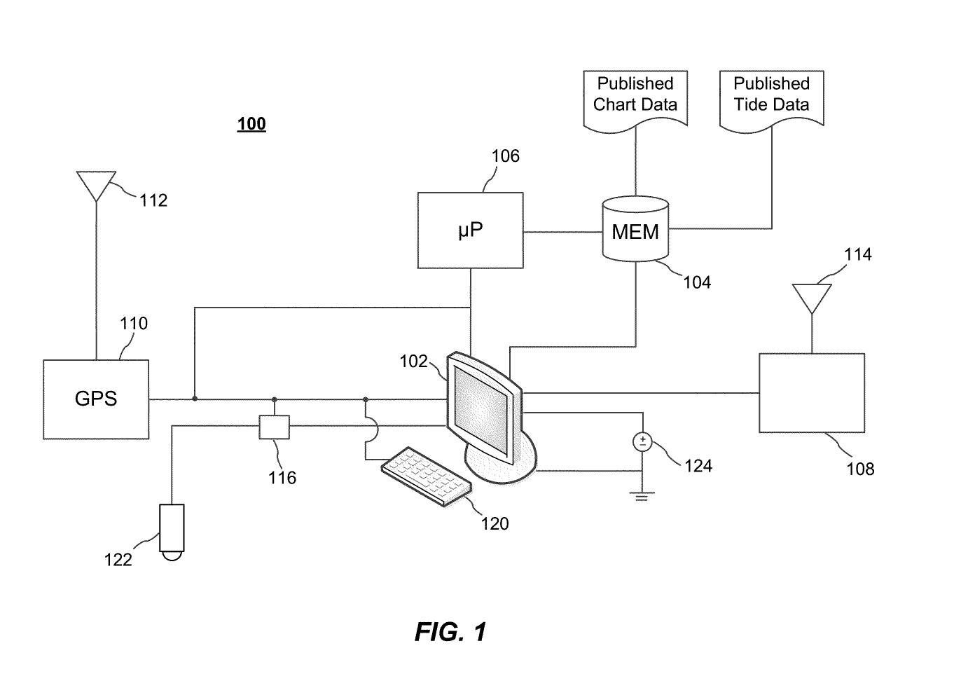

A navigational device for displaying real-time depth information according to an aspect of the present disclosure is described with reference to FIG. 1. The navigational device 100 includes a display 102 coupled to a memory 104. The memory is coupled to at least one processor 106. According to aspects of the present disclosure, the navigational device may be a chart plotter, a tablet computer, a general purpose computer or smart phone, for example. The navigational device may include wireless receiver circuitry 108 coupled to the processor (s) 106 and/or the memory 104. Optionally, the wireless receiver circuitry 108 may include a radio frequency receiver for receiving updated tide information from a weather service for example. Optionally, the navigational device may also include a global positioning system receiver coupled to the processor(s) 106 and/or the memory 104. The navigational device 100 may include a GPS antenna 112 coupled to the global positioning system receiver 110. The GPS antenna 112 may be internal to the navigational device 100 or may be configured externally. The navigational device 100 may also include a communications antenna coupled to the wireless receiver circuitry 100. The communications antenna 114 may be internal to the navigational device 100 or may be mounted externally.

Optionally, the navigational device 100 may include depth sounder (i.e., depth measurement) circuitry 116 coupled to the processor(s) and/or the memory 104. The depth sounder circuitry 116 may be configured internally to the navigational device 100 or may be configured in a separate unit coupled to the navigational device 100. The depth sounder circuitry 116 may be coupled to a depth transducer 122, for example.

The navigational device 100 may be powered by an internal power source such as an internal battery 124 or may be coupled to an external power source such as the electrical power system of a vessel. The navigational device 100, may also include a user input interface 120 such as a key pad or touch screen coupled to the processor(s) 106.

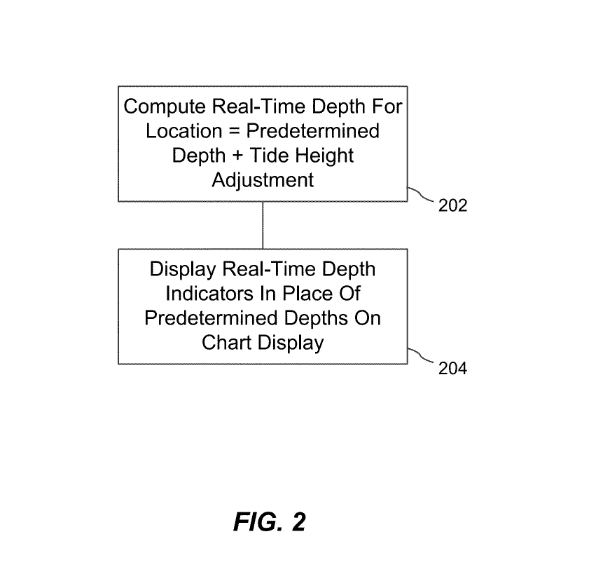

A method for displaying a navigational chart according to an aspect of the present disclosure is described with reference to FIG. 2. In block 202, the method includes determining a real time water depth of each of a plurality of corresponding locations depicted on the navigational chart based on a predetermined depth of the corresponding locations at a predetermined time relative to a tide cycle combined with a projected tide height at a selected time. At block 204, the method includes displaying real-time depth indicators at a corresponding locations on the navigational chart.

According to an aspect of the disclosure, the projected tide height at the selected time may be a published tide height estimate for the selected time at the corresponding location. According to an aspect of the present disclosure, the method includes replacing conventional soundings on navigational chart with the real-time depth indicators.

According to another aspect of the present disclosure, the method includes displaying a boundary displayed on the chart between a safe area and an unsafe area wherein the boundary is based on a present tide height and a vessel draft. According to another aspect of the present disclosure, the boundary may be based on a safety margin added to the vessel draft. According to another aspect of the present disclosure, the vessel draft and/or the safety margin may be input by a user. According to another aspect of the present disclosure, the boundary may be based on depth contours of a traditional navigational chart. According to an aspect of the present disclosure, the boundary may be based on. the real time depth indicators.

According to another aspect of the disclosure, the method includes replacing a number of published predetermined depth indicators, e.g., depth soundings, on a navigational chart the real time depth indicators. In one aspect the method includes replacing all of the depth soundings on at least a displayed portion of a navigational chart with the real time depth indicators. According to an aspect of the present disclosure, the predetermined depth is be a published depth for the location at mean low tide.

According to one aspect of the disclosure, the projected tide height at the selected time may be computed based on a position of celestial bodies at the selected time. According to another aspect of the present disclosure, the projected tide height may be based on projected weather conditions at the selected time at the corresponding location. According to another aspect of the present disclosure, the projected tide height at the selected time may be adjustable by a user. According to another aspect of the present disclosure, the selected time may be adjustable by a user. According to another aspect of the present disclosure, the selected time is the time of the displaying of the real time water depth.

According to an aspect of the present disclosure, the projected tide height at the selected time may be based upon a published depth at a vessel location adjusted by an actual sounding measured at the vessel location.

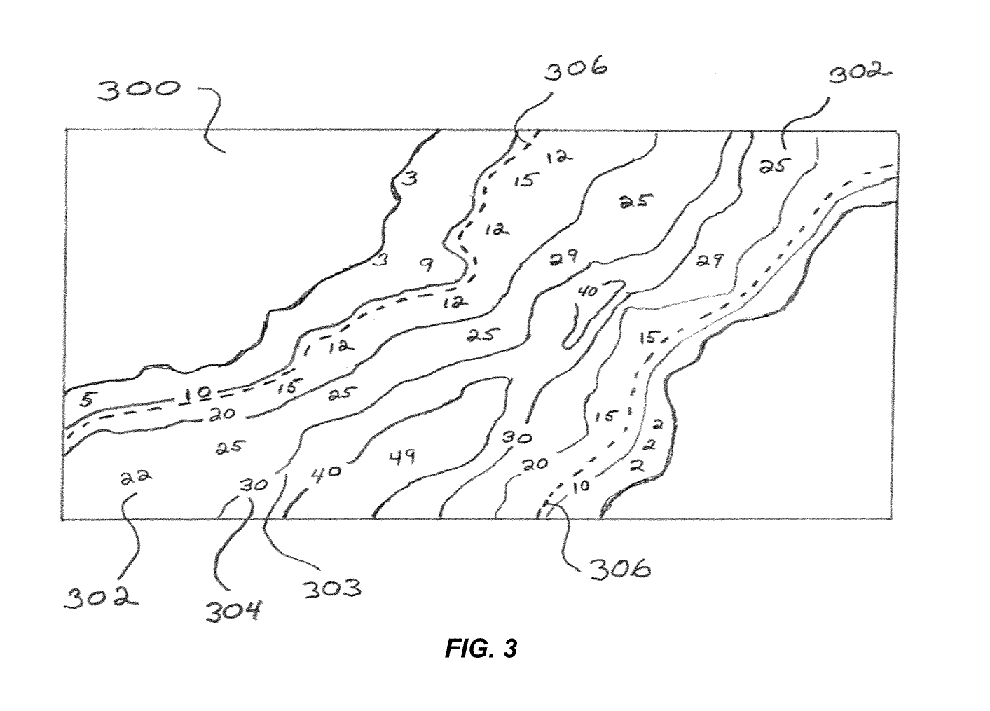

A display of real time depth information according to an aspect of the present disclosure is described with reference to FIG. 3. According to an aspect of the disclosure, the display 300 may appear substantially similar to a conventional navigational chart display on a chart plotter, for example, however the water depth indicators that are traditionally depicted on corresponding locations throughout the chart are replaced by real-time depth indicators 302. Depth indicators of contour lines 303 may also be replaced by real-time depth indicators 304 for the corresponding contour lines 303. Optionally, boundaries 306 are displayed. The boundaries 306 depict a demarcation between areas of safe operation for a particular draft vessel at a particular time and areas of unsafe operation for the vessel.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

As discussed above, the various aspects of the present disclosure may be implemented in a wide variety of operating environments, which in some cases may include one or more mobile devices, user computers, computing devices, or processing devices which may be used to operate any of a number of applications. Mobile devices may include any of a number of cellular wireless and handheld devices such as mobile phones, smart phones and tablet computers running mobile software and capable of supporting a number of networking and messaging protocols. User computers and computing devices may include laptop computers and general purpose personal computers running a standard operating system, for example Such a system also may include a number of workstations running any of a variety of commercially-available operating systems and other known applications for purposes such as development and database management. These devices also may include other electronic devices, such as dummy terminals, thin-clients, gaming systems, and other devices capable of communicating via a network.

The environment may include a variety of data stores and other memory and storage media as discussed above. These may reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device may include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also may include a computer-readable storage media reader, a communications device (e.g., a modem, a network card (wireless or wired), an infrared communication device, etc.), and working memory as described above. The computer-readable storage media reader may be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Based on the disclosure and teachings provided herein, a person of ordinary skill in the art will appreciate other ways and/or methods to implement the various aspects and embodiments. The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus for displaying a navigational chart comprising:
real-time depth indicators displayed at corresponding locations on the navigational chart,
the real time depth indicators displaying a real time water depth of each of the corresponding locations, in which each of the real time water depths are generated based on a predetermined depth of the corresponding location at a predetermined time relative to a tide cycle combined with a projected tide height at a selected time.

2. The apparatus of claim 1 in which the depth indicators replace conventional soundings on navigational chart.

3. The apparatus of claim 1, further comprising:
a boundary displayed on the chart between a safe area and an unsafe area, the boundary based on a present tide height and a vessel draft.

4. The apparatus of claim 3, in which the boundary is based on a safety margin added to the vessel draft.

5. The apparatus of claim 4 in which the vessel draft and/or the safety margin may be input by a user.

6. The apparatus of claim 3 in which the boundary is based on depth contours of a traditional navigational chart.

7. The apparatus of claim 3, in which the boundary is based on the real time depth indicators.

8. The apparatus of claim 1 wherein the projected tide height at the selected time is a published tide height estimate for the selected time at the corresponding location.

9. The apparatus of claim 1 in which the predetermined depth comprises a published depth for the location at mean low tide.

10. The apparatus of claim 1 wherein the projected tide height at the selected time is computed based on a position of celestial bodies at the selected time.

11. The apparatus of claim 1 wherein the projected tide height is based on projected weather conditions at the selected time at the corresponding location

12. The apparatus of claim 1 wherein the projected tide height at the selected time is adjustable by a user

13. The apparatus of claim 1 wherein the selected time is adjustable by a user

14. The apparatus of claim 1 wherein the selected time is the time of the displaying of the real time water depth.

15. The apparatus of claim 1, wherein the projected tide height at the selected time is based upon a published depth at a vessel location adjusted by an actual sounding measured at the vessel location.

16. A method for displaying a navigational chart comprising:
determining a real time water depth of each of a plurality of corresponding locations depicted on the navigational chart based on a predetermined depth of the corresponding locations at a predetermined time relative to a tide cycle combined with a projected tide height at a selected time; and
displaying real-time depth indicators at a corresponding locations on the navigational chart.

17. The method of claim 16 wherein the projected tide height at the selected time is a published tide height estimate for the selected time at the corresponding location.

18. The method of claim 16 comprising replacing conventional soundings on navigational chart with the real-time depth indicators.

19. The method of claim 16 further comprising:
displaying a boundary displayed on the chart between a safe area and an unsafe area, the boundary based on a present tide height and a vessel draft.

20. A navigational chart plotter comprising:
at least one processor programmed to perform steps of:
determining a real time water depth of each of a plurality of corresponding locations depicted on the navigational chart based on a predetermined depth of the corresponding locations at a predetermined time relative to a tide cycle combined with a projected tide height at a selected time; and
generating an image including real-time depth indicators at a corresponding locations on the navigational chart;
a memory coupled to the processor, the memory configured to store the image; and
a display coupled to the memory, the display configured to display the image.
